(19) United States
(12) Patent Application Publication
(10) Pub. No.: US 2017/0004814 A1
(43) Pub. Date: Jan. 5, 2017

(54) ACOUSTIC ELECTRONIC DEVICE DOCK

(71) Applicant: Mark W. SCHELLER, Lemoyne, PA (US)

(72) Inventor: Mark W. SCHELLER, Lemoyne, PA (US)

(21) Appl. No.: 15/039,811

(22) PCT Filed: Dec. 5, 2014
(86) PCT No.: PCT/US14/68805

§ 371 Date: May 26, 2016

Related U.S. Application Data
(60) Provisional application No. 61/912,760, filed on Dec. 6, 2013.

(51) Int. Cl. G10K 11/08; H04R 1/34; G10K 11/28

(52) U.S. Cl. CPC G10K 11/08; G10K 11/28; H04R 1/345

(57) ABSTRACT

Acoustic docks and methods of forming the same, as well as methods of amplifying sound are disclosed herein. An acoustic dock may include a surface having a recess. The recess may be configured such that sound emitted from an electronic device is passively reflected against the recess to at least one area facing the surface when the electronic device is placed in the recess.

### CROSS-REFERENCE TO RELATED APPLICATIONS

The present application claims the benefit of and priority to U.S. Provisional Application Ser. No. 61/912,760 entitled “ACOUSTIC ELECTRONIC DEVICE DOCK,” which was filed Dec. 6, 2013. The aforementioned application is incorporated by reference herein in its entirety and for all purposes.

### BACKGROUND

Electronic devices, particularly mobile electronic devices such as smartphones, tablets, and the like are increasingly used for a wide range of purposes, such as for communication, entertainment, business, education, and/or the like. In some instances, such as when viewing a video, participating in a video chat, or listening to music, it may be desirable to stand the electronic device such that it can be viewed and/or heard without a need for holding the device.

Manufacturers of electronic devices sometimes install speakers in the electronic devices that are of poor quality and/or are unsuitable for their intended use. In addition, the speakers may be perceived as having poor quality by a user or may not meet a user's expectations or desires. Previous attempts to solve this problem have included the manufacture of docking stations that are equipped with more powerful and/or better quality speakers and can receive an electronic device via a plug, an adaptor, a port, and/or the like. However, such speaker systems are costly, may be configured to dock with only certain types of electronic devices, may need to be approved by the electronic device manufacturer before they can be manufactured, may require a power source to function, may not be portable, may block various ports and/or connections on the electronic device, or may not be aesthetically pleasing.

Additional attempts to solve the problem of poor quality speakers have included docks that use a gramophone style device that incorporates a flared sound amplifying portion. The flared sound amplifying portion may be, for example, horn or box shaped. However, such devices require specific alignment of the speaker on the electronic device with the sound amplifying portion to ensure proper amplification of sound. Thus, even slight misplacements of the electronic device may prevent the sound from being properly amplified. In addition, the orientation of the electronic device must be maintained to ensure appropriate speaker alignment. Furthermore, such devices must be manufactured to specific electronic device specifications, have complex waveguide patterns, have multiple parts that may get lost or may break, and require device-specific adaptors that may get lost or may break, which would render the dock useless. The docks may also block various ports and/or connections on the electronic device so that the user would not be able to use the ports while using the dock.

### SUMMARY

In an embodiment, an acoustic dock may include a surface having a recess. The recess may be configured such that sound emitted from an electronic device is passively reflected against the recess to at least one area facing the surface when the electronic device is placed in the recess.

In an embodiment, a method of amplifying sound emitted from an electronic device may include placing the electronic device in an acoustic dock having a surface with a recess. At least one portion of the recess may be curved. The sound may be passively reflected against the at least one curved portion to at least one area facing the surface.

In an embodiment, a method of forming an acoustic dock may include providing a material, forming the material into a shape, and forming a recess in the shape. The recess may be curved such that sound emitted from an electronic device is passively reflected against the recess to at least one area facing the surface when the electronic device is placed in the recess.

### BRIEF DESCRIPTION OF THE DRAWINGS

FIG. 1 depicts a perspective view of an illustrative acoustic electronic device dock according to an embodiment.

FIG. 2A depicts a front elevational view of the acoustic electronic device dock with an electronic device mounted in a landscape orientation according to an embodiment.

FIG. 2B depicts a front elevational view of the acoustic electronic device dock with an electronic device mounted in a portrait orientation according to an embodiment.

FIG. 3 depicts a schematic diagram of a shape of a recess in the acoustic electronic device dock according to an embodiment.

FIG. 4 depicts a side elevational view of the acoustic electronic device dock according to an embodiment.

FIG. 5 depicts a rear elevational view of the acoustic electronic device dock according to an embodiment.

FIG. 6 depicts a flow diagram of a method of forming an illustrative acoustic electronic device dock according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

An electronic device refers to a device capable of creating or reproducing sound. The electronic device includes a processing device and a tangible, computer-readable memory or storage device. The memory may contain programming instructions that, when executed by the processing device, cause the device to perform one or more operations according to the programming instructions. Illustrative examples of electronic devices include personal computers, gaming systems, televisions, and mobile devices.

A mobile device refers to an electronic device that is generally portable in size and nature. Accordingly, a user may transport a mobile device with relative ease. Illustrative examples of mobile devices include pagers, cellular phones, feature phones, smartphones, personal digital assistants (PDAs), cameras, tablet computers, phone-tablet hybrid devices (“phablets”), laptop computers, netbooks, ultrabooks, global positioning satellite (GPS) navigation devices, in-dash automotive components, media players, watches, fitness trackers, and the like.

A dock refers to any device or structure that is generally configured to support placement of an electronic device in a position that may be desired by a user. Illustrative docks include various platforms, enclosures, support devices, ledges, bulkheads, and/or the like. The dock may be permanently fixed or movable.

The present disclosure relates generally to devices that are configured to autonomously cradle an electronic device. The devices described herein are generally shaped and sized to hold an electronic device, to passively reflect sound emitted by the electronic device in a direction that is generally toward the user of the electronic device, and/or to passively amplify sound emitted by the electronic device. Because the devices described herein are purely passive, they need not incorporate particular parts such as vibrating amplifiers, Helmholtz resonators, or the like. Thus, the devices disclosed herein need not electronically interface with an electronic device to function. Accordingly, the devices disclosed herein are electronic device-agnostic. Furthermore, the devices disclosed herein need not draw electrical power from an external source or an electronic device, thereby avoiding excessive drain on the electronic device's battery. However, in some embodiments, the devices disclosed herein may incorporate various docking ports and/or openings so that a user can optionally charge or otherwise access ports on the electronic device while it is being cradled.

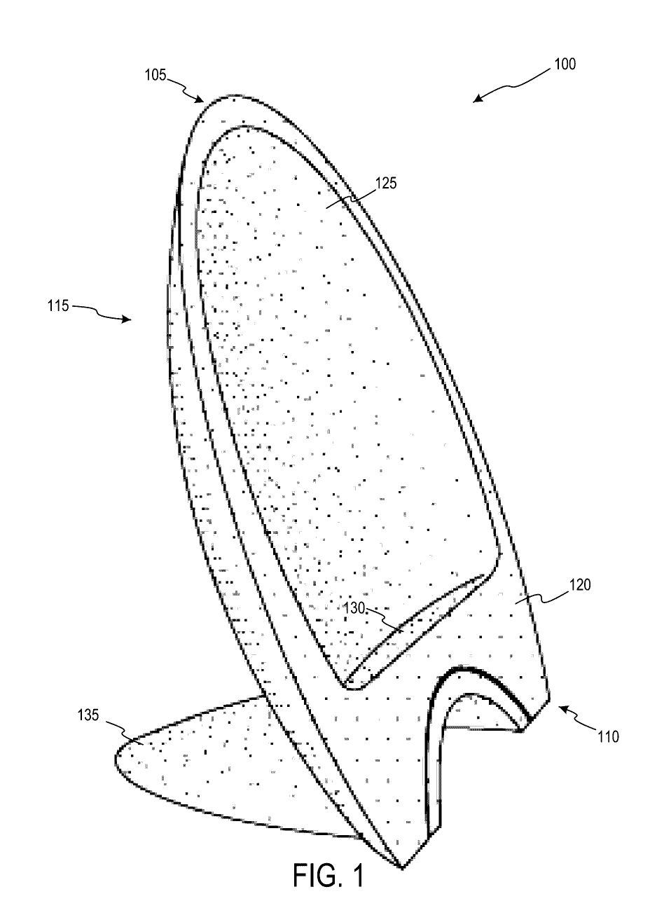

FIG. 1 depicts a perspective view of an acoustic electronic device dock, generally designated 100, according to an embodiment. The dock 100 may generally have a top portion 105, a bottom portion 110, a front face 120, and a rear face 115. The dock 100 may generally be made of any material. Accordingly, the material is not limited by this disclosure. Illustrative materials may include wood, polymer, polymer-based materials, polymer-coated materials, paper, paper-based materials, metal, metal-based materials, metal-coated materials, fabrics, and/or the like. In addition, the dock 100 may generally have any size and/or shape, subject to limitations specifically described herein. In some embodiments, the dock 100 may be any color, including a combination of different colors.

In some embodiments, the dock 100 may be transparent such that a user is able to see through at least a portion of the dock. Accordingly, the dock 100 may be mounted in a location where it may be advantageous to not obstruct a user's view, such as, for example, a vehicle dashboard such that the user can see through the dock when driving. In other embodiments, the dock 100 may be opaque. In some embodiments, various portions of the dock 100 may be opaque, and other portions of the dock may be transparent.

In some embodiments, various portions of the dock 100 may contain one or more indicia, etchings, drawings, images, logos, and/or the like. The location and size of such indicia, etchings, drawings, images, logos, and/or the like are not limited by this disclosure, and may be of any size that is suitable for the dock 100 and at any location on the dock. For example, in some embodiments, the dock 100 may have a logo, such as a corporate logo, on the rear face 115. In particular embodiments, the dock 100 may have etchings such that, when the dock is illuminated by a light source (such as a flash on the electronic device), the etchings are accentuated by the light. Similarly, the dock 100 may incorporate any number of devices configured to emit light such that at least a portion of the dock is illuminable.

In some embodiments, the dock 100 is configured to passively reflect and/or amplify sound, thereby obviating a need for electrical components for sound reflection and/or amplification. In alternate embodiments, the dock 100 may incorporate one or more electrical components, such as components that provide electricity to the electronic device. For example, an electrical component may allow for charging and/or syncing of the electronic device when it is placed in the dock. Thus, the dock 100 may incorporate universal serial bus (USB) ports, micro-USB ports, mini-USB ports, networking (such as Ethernet) ports, 30-pin ports, Lightning® connector ports (Apple, Inc. Cupertino, Calif.), and/or the like. In some embodiments, the dock 100 may be configured for wireless syncing and/or charging. In some embodiments, the dock 100 may be configured to be plugged into an electrical outlet. In some embodiments, the dock 100 may be configured to be plugged into an external electronic device, such as a personal computer or the like.

The bottom portion 110 may be sized and shaped to allow the dock 100 to stand on a surface in a vertical, substantially vertical, or reclining vertical position. In some embodiments, the bottom portion 110 may attach to a base piece 135 that provides additional support in allowing the dock 100 to stand on a surface in a vertical, substantially vertical, or reclining vertical position. In some embodiments, the base piece 135 may be permanently affixed to the bottom portion 110 by any means of fixture, including, for example, adhesives, hardware, and/or the like. In particular embodiments, the base piece 135 may be formed as a portion of the dock 100 such that the base piece is a component of the dock. In other embodiments, the base piece 135 may be removably affixed to the bottom portion 110 by any means of fixture, including, but not limited to, magnetic fixture, hook and loop fixture, tongue and groove fixture, and/or the like. In some embodiments, the base piece 135 may be movably configured with respect to the bottom portion 110 such that the dock 100 can be angled to suit a user's preferences and/or viewing needs.

In various embodiments, the front face 120 may comprise a surface having a recess 125 therein. The recess 125 may be sufficiently configured to receive an electronic device therein. In some embodiments, the electronic device may be placed entirely in the recess 125. In other embodiments, the electronic device may be partially placed in the recess 125. In still other embodiments, the electronic device may be placed adjacent to the recess 125.

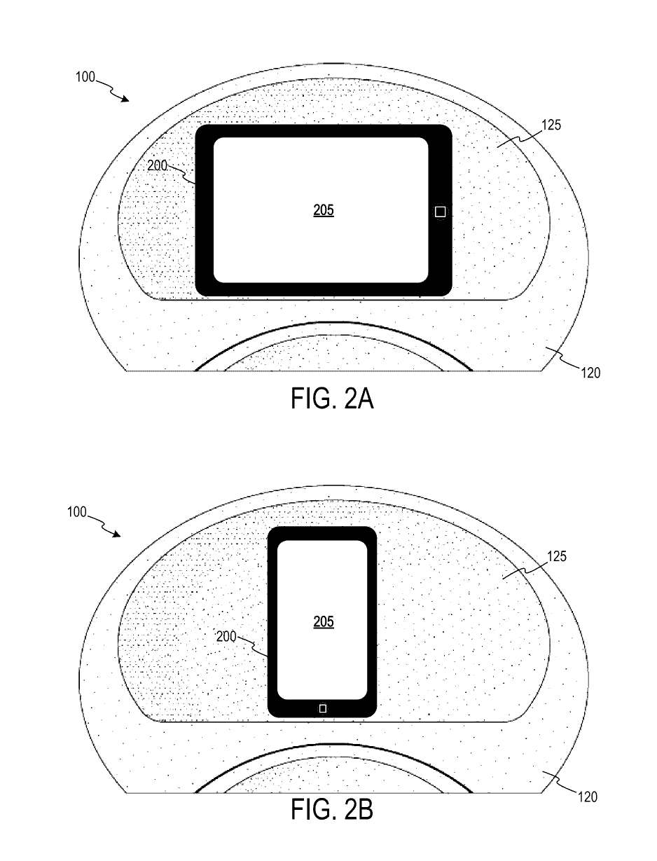

The orientation of the electronic device in the recess 125 is not limited by this disclosure and may include any orientation. For example, as shown in FIG. 2A, the electronic device 200 may be oriented in a landscape mode within the recess 125. In another example, as shown in FIG. 2B, the electronic device 200 may be oriented in a portrait mode within the recess 125. In some embodiments, the electronic device 200 may generally be oriented such that a viewable portion 205 of the electronic device is substantially aligned with the front face 120 so that a user can view the viewable portion.

In some embodiments, the electronic device 200 may generally be oriented such that a sound emitting portion (i.e., speaker) of the electronic device is adjacent to at least a portion of the recess 125. Accordingly, the recess may reflect and/or amplify sounds emitted by the speaker portion of the electronic device 200, as described in greater detail herein. In some embodiments, the electronic device 200 may generally be oriented such that a microphone portion of the electronic device is adjacent to at least a portion of the recess 125 such that the recess reflects sound from an area surrounding the dock 100 and funnels the sound towards the microphone portion of the electronic device. Thus, the recess 125 is device-agnostic and configured to hold any device, regardless of shape, size, speaker placement, number of speakers, microphone placement, number of microphones, viewable portion placement, and/or the like. Accordingly, the dock 100 need not be restricted to a particular device, require adaptor accessories for connecting multiple devices, or require manufacture of several device-specific models.

In various embodiments, the recess 125 may be configured such that the electronic device can be easily placed within the recess and easily removed by a user. In some embodiments, easy placement may include allowing the user to place the electronic device at any location within the recess 125 and still obtain various sound qualities described in greater detail herein. Thus, precise positioning of the electronic device 200 within the recess 125 may not be required. Rather, the dock 100 may properly reflect and/or amplify sound regardless of the location regardless of the positioning of the electronic device 200 within the recess 125. Accordingly, a user can place the electronic device 200 in the dock 100 without concern for whether the electronic device is in a precise location. Easy placement may further include a lack of movement or positioning of parts to ensure optimum sound quality as described in greater detail herein. Thus, unlike in some acoustic docks, a user may avoid specific placement of the electronic device into the recess 125. In addition, the user may not be required to maintain device orientation within the dock during use, attach a sound reflecting device, horn, or waveguide, attach the device to the dock 100, adjust an outlet opening to prevent sound distortion, and/or the like as may be required by other docks.

In some embodiments, the recess 125 may include a ledge 130. The ledge 130 is not limited by this disclosure and may generally be a structure for supporting an electronic device 200 in the recess 125. In some embodiments, the ledge 130 may have a protective coating, such as a non-slip or non-skid coating to prevent the electronic device 200 from slipping off the dock 100. In some embodiments, the ledge 130 may have a lip or similar structure to prevent the electronic device 200 from slipping off the dock 100. In some embodiments, the ledge 130 may be sufficiently sized and shaped such that the electronic device 200 rests entirely within the recess 125 and does not protrude from the face 120 of the dock 100. In other embodiments, the ledge 130 may be sized and shaped such that the electronic device 200 protrudes from the face 120 of the dock 100. In some embodiments, the ledge 130 may be adjustable such that a desired viewing angle of the electronic device 200 can be obtained. In some embodiments, the ledge 130 may contain one or more openings to allow one or more cables to pass therethrough. The cables may connect to the electronic device 200 and an external device, such as, for example, a computer, a power source, and/or the like. In some embodiments, the ledge 130 may contain one or more integrated ports so that the electronic device 200 can be plugged into the integrated port for charging and/or syncing while it is located in the dock 100. Such openings and integrated ports may be configured so as to not substantially interfere with sound amplification or reflection, as described in greater detail herein.

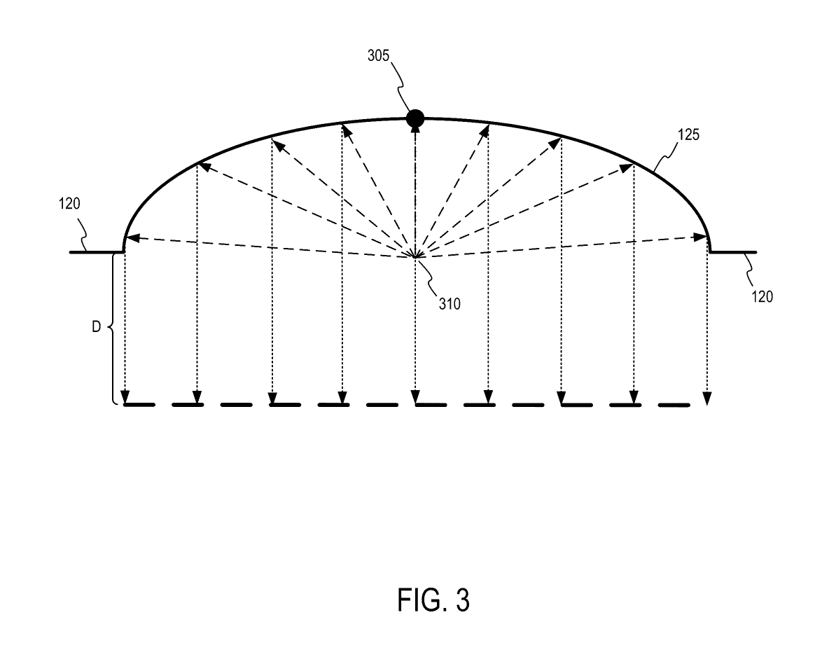

Referring to FIG. 3, the recess 125 may generally be configured such that any portion of the recess can reflect sound waves to and from an electronic device positioned within the recess, regardless of device size, location, orientation, speaker location, microphone location, and/or the like. Those with ordinary skill in the art will recognize various shapes and/or sizes of the recess 125 that cause the sound waves to be directed to a particular location, to be focused, to be scattered, to exhibit a rotunda effect, and/or the like. For example, in some embodiments, the recess 125 may be configured such that the dock 100 provides maximum reflection of sound for a particular electronic device with particular speaker and/or microphone placement. Maximum reflection of sound may include sound reflection at a plurality of angles, such as, for example, a reflection angle of about 10° to about 180° in any direction from the recess 125 with respect to the surface of the recess, including about 10°, about 20°, about 30°, about 40°, about 50°, about 60°, about 70°, about 80°, about 90°, about 100°, about 110°, about 120°, about 130°, about 140°, about 150°, about 160°, about 170°, about 180°, or any value or range between any two of these values (including endpoints). Maximum reflection may also include reflection of sound waves up to a particular distance away from the dock 100, as described in greater detail herein.

In various embodiments, the recess 125 may generally be configured such that any portion of the recess can redirect and/or amplify sound waves emitted by an electronic device positioned within the recess. For example, a curved surface of the recess 125 may passively redirect and/or passively amplify sound. Those with ordinary skill in the art will recognize that any configuration of the recess 125 can cause the sound from the electronic device to be amplified. For example, in some embodiments, the recess 125 may be configured such that the dock 100 amplifies the sound emitted from the electronic device about 1 decibel (dB) louder than the sound emitted from the electronic device 200 without the dock to about 100 dB louder, including about 1 dB, about 5 dB, about 10 dB, about 15 dB, about 20 dB, about 25 dB, about 50 dB, about 75 dB, about 100 dB, or any value or range between any two of these values (including endpoints). In some embodiments, the recess 125 may be configured such that it reflects any frequency of sound or a wide spectrum of frequencies. Illustrative frequencies may include about 16 hertz (Hz) to about 17 kilohertz (kHz), including about 16 Hz, about 20 Hz, about 25 Hz, about 50 Hz, about 100 Hz, about 500 Hz, about 1 kHz, about 5 kHz, about 10 kHz, about 15 kHz, about 17 kHz, or any value or range between any two of these values (including endpoints). Specific frequencies may include about 32 Hz, about 512 Hz, about 2048 Hz (about 2.048 kHz), about 8192 Hz (about 8.192 kHz), about 16,384 Hz (about 16.384 kHz), or any value or range between any two of these values (including endpoints). In some embodiments, the recess 125 may be configured to reflect about 16 Hz to about 32 Hz, about 32 Hz to about 512 Hz, about 512 Hz to about 2048 Hz, about 2048 Hz to about 8192 Hz, or about 8192 Hz to about 16,384 Hz. Thus, the recess 125 avoids a known shortcoming of various other amplifiers, such as gramophone style devices, horn shaped devices, waveguide devices, and/or the like that reflect and/or amplify certain frequencies while failing to reflect and/or amplify other frequencies.

In some embodiments, the recess 125 can be configured to absorb sound waves emitted by an electronic device positioned within the recess and/or emitted from objects adjacent to the recess. In particular embodiments, the recess 125 may contain a coating, an insert, and/or the like to cause absorption of sound waves. In some embodiments, the recess 125 may be configured to absorb only certain frequencies of sound waves while reflecting other frequencies. For example, the recess 125 may be configured to absorb background noise at low frequencies while at the same time allowing human voices at higher frequencies to be reflected and/or amplified. Such a configuration may allow, for example, the dock 100 to be used successfully with the electronic device 200 as a communications apparatus in noisy environments. Thus, for example, a user could initiate a video chat using an electronic device 200 placed in the recess 125. The recess 125 may absorb background noise while amplifying and redirecting the user's voice to a microphone on the electronic device 200 so a user on the other end of the video chat can hear the user more clearly.

In various embodiments, the shape of the recess 125 may generally be curved. Curvature is not limited by this disclosure and may be any regular or irregular curve. For example, one such shape of the recess 125 may be generally parabolic such that a vertex 305 of the parabola is located substantially near a center portion of the recess 125 and a focus 310 of the parabola is located at or near the surface 120. In some embodiments, the focus 310 of the curved recess may be located generally at a location where sound is emitted, such as, for example, at or near a speaker on an electronic device. A user situated in front of the dock 100 may be located at or near the focus, or may be located at a distance D away from the dock. The distance D is not limited by this disclosure and may be any reasonable distance that the sound waves emitted from the dock may travel. Illustrative distances may include about 10 centimeters (cm) to about 10 meters (m), including about 10 cm, about 50 cm, about 1 m, about 2 m, about 3 m, about 4 m, about 5 m, about 6 m, about 7 m, about 8 m, about 9 m, about 10 m, or any value or range between any two of these values (including endpoints). As such, sound emitted from an electronic device at the focus 310 will reflect off the curved recess 125 towards a user, as indicated by the arrows in FIG. 3. In some embodiments, curvature of the recess 125 may include one or more anti-focusing features (not shown). Such anti-focusing features may be integrated within the recess 125 to ensure an even dispersion of sound that is reflected by the dock 100. As a result, areas surrounding the dock may have consistent sound levels.

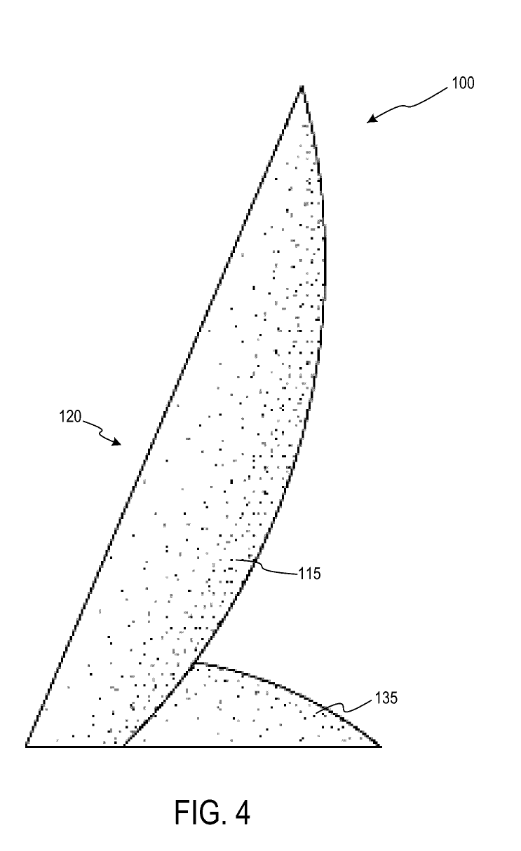

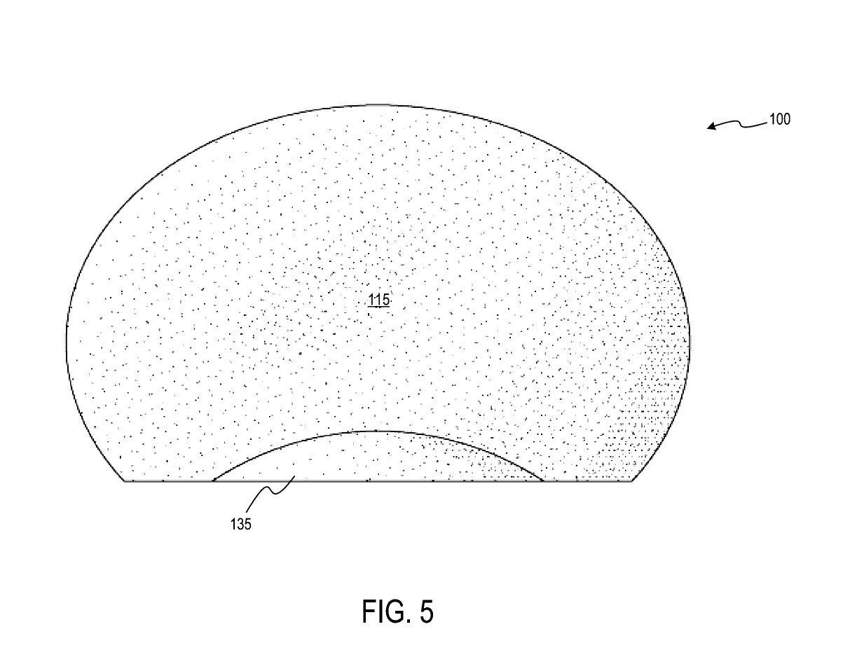

In various embodiments, as depicted in FIGS. 4 and 5, the recess 125 (FIG. 1) may be shaped such that it mirrors the shape of the rear face 115 of the dock 100. Accordingly, in some embodiments, the rear face 115 may also have a surface that is substantially curved, as described herein. In other embodiments, the rear face 115 may be shaped independently of the recess 125 (FIG. 1). In such embodiment, the rear face 115 may generally be any shape and/or size. For example, in some embodiments, the rear face 115 may have a substantially flat surface. In some embodiments, the rear face 115 may have a textured surface. In some embodiments, the rear face 115 may include indicia, an etching, a drawing, an image, a logo, and/or the like, as described in greater detail herein. In some embodiments, the rear face 115 may be omitted. In some embodiments, the rear face 115 may contain one or more mounting features thereon (not shown). The mounting features may be configured such that the dock 100 can be mounted to a surface, such as, for example, a wall or the like.

A user may use the dock 100 by placing an electronic device in the dock and activating the electronic device and/or features thereon. For example, a user desiring to watch a video on an electronic device may place the electronic device within the dock 100 and initiate playback of the video. The shape and size of the dock 100, as described in greater detail herein, will passively amplify and/or passively reflect the sound emitted from the electronic device without additional configuration.

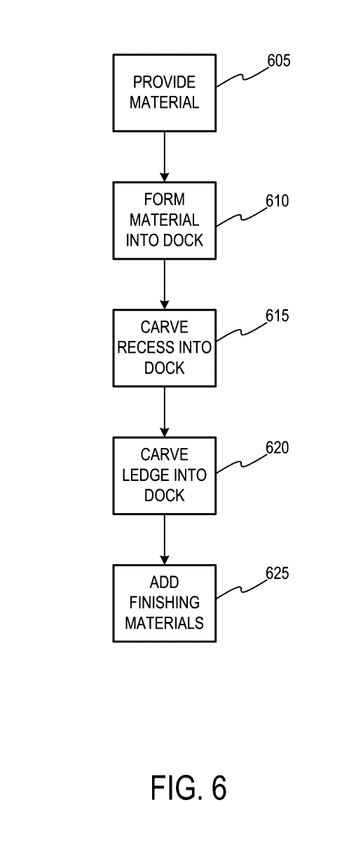

FIG. 6 depicts a flow diagram of a method of forming the dock according to an embodiment. In various embodiments, a material may be provided 605. Providing 605 the material may include providing a solid block of material, providing a formable material such as a melted polymer, and/or the like.

In various embodiments, the material may be formed 610. Forming 610 the material may include cutting, carving, whittling, tooling, sanding, buffing, injection molding, thermoforming, and/or the like. The material may generally be formed 610 into a shape and/or size that is desired for the dock based on various characteristics described in greater detail herein. In some embodiments, a recess may be carved 615 into the dock after the dock is formed 610. In some embodiments, forming 610 may include carving 615 the recess into the dock. In other embodiments, a dock may be formed 610 with a recess, such as via an injection molding process where a mold contains the recess or a wood carving process where the forming is truncated to form the recess. In such embodiments, the carving 615 operation may not be performed.

Similarly, in some embodiments, a ledge may be carved 620 into the dock after the dock is formed 610. In some embodiments, forming 610 may include carving 620 the ledge into the dock. In some embodiments, carving 615 the recess into the dock may include carving 620 the ledge. In other embodiments, a dock may be formed 610 with a ledge, such as via an injection molding processes where a mold contains the ledge. In such embodiments, the carving 620 operation may not be performed. In some embodiments, forming 610 may include forming one or more separate components of the dock.

In various embodiments, one or more finishing materials may be added 625 to the dock. Finishing materials that may be added 625 may include any number of coatings, carvings, etchings, drawings, image and/or logo applications, stickers, decals, addition of ports, openings, and/or the like. In some embodiments, the one or more finishing materials may include various etchings, carvings, and/or the like that are configured for shadow casting. Thus, when a user places a light source at a location in front of or behind the dock, the light is reflected through the dock such that a shadow is formed on the opposite side of the dock from the light source, such as a wall and/or the like located behind the dock. The shadow may have any shapes, letters, designs, and/or the like that are formed into the dock via the etchings, carvings, and/or the like.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art, all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. An acoustic dock comprising a surface having a recess, wherein the recess is configured to receive an electronic device and passively reflect sound emitted from the electronic device to at least one area facing the surface.

2. The acoustic dock of claim 1, wherein the recess is further configured to passively amplify the sound emitted from the electronic device to the at least one area.

3. The acoustic dock of claim 2, wherein the recess is configured to passively amplify the sound by at least about 1 decibel (dB) to about 100 dB louder than the sound is emitted by the electronic device.

4. The acoustic dock of claim 1, wherein the recess is further configured to reflect sound from an area adjacent to the acoustic dock towards a microphone portion of the electronic device.

5. The acoustic dock of claim 1, wherein at least one portion of the recess is curved.

6. The acoustic dock of claim 1, wherein the recess is a parabolic recess such that a vertex of the parabolic recess is located substantially near a center portion of the recess and a focus of the parabolic recess is located at the surface.

7. The acoustic dock of claim 1, wherein the recess is a parabolic recess such that a vertex of the parabolic recess is located substantially near a center portion of the recess and a focus of the parabolic recess is located at a sound emitting portion of the electronic device.

8. The acoustic dock of claim 1, wherein the recess is further configured to absorb sound at one or more frequencies.

9. The acoustic dock of claim 1, further comprising a ledge integrated with the recess, wherein the ledge is configured to support the electronic device in the recess.

10. The acoustic dock of claim 1, further comprising a base piece configured to provide support for the acoustic dock on a horizontal surface.

11. The acoustic dock of claim 1, further comprising one or more electrical components configured to provide a source of electricity for the electronic device.

12. The acoustic dock of claim 1, wherein the acoustic dock is constructed of one or more of the following: wood, polymer, a polymer-based material, a polymer-coated material, paper, a paper-based material, metal, a metal-based material, a metal-coated material, and a fabric.

13. The acoustic dock of claim 1, wherein the acoustic dock is constructed of a transparent material.

14. The acoustic dock of claim 1, further comprising one or more etchings on the surface.

15. The acoustic dock of claim 14, wherein the one or more etchings are configured to be accentuated upon illumination of the acoustic dock by a light source.

16. A method of amplifying sound emitted from an electronic device, the method comprising:
placing the electronic device in an acoustic dock comprising a surface having a recess, wherein at least one portion of the recess is curved,
wherein the sound is passively reflected against the at least one curved portion to at least one area facing the surface.

17. A method of forming an acoustic dock, the method comprising:
providing a material;
forming the material into a shape; and
forming a recess in the shape, wherein the recess is curved such that sound emitted from an electronic device is passively reflected against the recess to at least one area facing the surface when the electronic device is placed in the recess.

18. The method of claim 17, wherein forming the material comprises carving the material into the shape.

19. The method of claim 17, wherein forming the material comprises injection molding the material into the shape.

20. The method of claim 17, wherein forming the material comprises thermoforming the material into the shape.
